(19) United States
(12) Patent Application Publication
(10) Pub. No.: US 2026/0179836 A1
(43) Pub. Date: Jun. 25, 2026

(54) MULTILAYER CERAMIC CAPACITOR

(71) Applicant: Murata Manufacturing Co., Ltd., Nagaokakyo-shi (JP)

(72) Inventor: Keisuke NOMURA, Nagaokakyo-shi (JP)

(21) Appl. No.: 19/413,071

(22) Filed: Dec. 9, 2025

(30) Foreign Application Priority Data
Dec. 20, 2024 (JP) 2024-225787

(51) Int. Cl. H01G 4/008; H01G 4/232; H01G 4/30

(52) U.S. Cl. CPC H01G 4/008; H01G 4/232; H01G 4/30

(57) ABSTRACT

A multilayer ceramic capacitor includes an inner layer portion in which inner dielectric layers and internal electrode layers are alternately laminated. The internal electrode layers include electrode discontinuous portions where the internal electrode layers are discontinuous in counter electrode portions. When viewed in a cross section parallel or substantially parallel to a lamination direction and a length direction, a ratio of a total area of pores each having a circumscribed circle diameter of about 500 nm or more relative to a total area of the electrode discontinuous portions is lower at an end portion of the counter electrode portions, than at a middle portion of the counter electrode portions by about 15 percentage points or more.

### CROSS REFERENCE TO RELATED APPLICATIONS

This application claims the benefit of priority to Japanese Patent Application No. 2024-225787 filed on Dec. 20, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

In the prior art, multilayer ceramic capacitors each include a multilayer body in which dielectric layers and internal electrode layers are alternately laminated, with dielectric layers further laminated on the upper and lower surfaces thereof, and a pair of external electrodes provided on both end surfaces of the multilayer body. The internal electrode layers each include a counter electrode portion that generates capacitance and an extension electrode portion extending from the counter electrode portion toward one of the external electrodes.

In recent years, by reducing the thickness of the dielectric layers and internal electrode layers with the advancement of electronics technology, the number of laminated dielectric layers and internal electrode layers increase, and the reduction in size and increase in capacitance of multilayer ceramic capacitors are being advanced.

However, electrode discontinuous portions where the internal electrode layers are discontinuous may exist in the counter electrode portions of the internal electrode layers. In these electrode discontinuous portions, electric field fringing occurs, causing electric field concentration and shortening the life of the multilayer ceramic capacitor. In particular, when the thickness of the internal electrode layers is reduced, electrode discontinuous portions are likely to be formed at the ends of the counter electrode portions, resulting in a decrease in the high-temperature reliability of the multilayer ceramic capacitor.

### SUMMARY OF THE INVENTION

Example embodiments of the present invention provide multilayer ceramic capacitors that each reduce or prevent electric field fringing in electrode discontinuous portions in the counter electrode portions of internal electrode layers and each have improved high-temperature reliability.

The present inventor of example embodiments of the present invention discovered that the high-temperature reliability of a multilayer ceramic capacitor is improved by adjusting the ratio of the total area of pores each having a predetermined size to the total area of electrode discontinuous portions, or the ratio of the total area of regions where a predetermined element segregates to the total area of electrode discontinuous portions, in the middle portion and end portion of the counter electrode portions of the internal electrode layers, and completed example embodiments of the present invention.

An example embodiment of the present invention provides a multilayer ceramic capacitor which includes a multilayer body including an inner layer portion including a plurality of inner dielectric layers and a plurality of internal electrode layers that are alternately laminated in a lamination direction, and outer layer portions sandwiching the inner layer portion from the lamination direction, the multilayer body further including two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction, and a pair of external electrodes each on a corresponding one of the two end surfaces and each connected to the plurality of internal electrode layers. The plurality of internal electrode layers each include electrode discontinuous portions where the plurality of internal electrode layers are discontinuous in counter electrode portions thereof where adjacent ones of the plurality of internal electrode layers in the lamination direction are opposed to each other. When viewing a cross section parallel or substantially parallel to the lamination direction and the length direction, a ratio of a total area of pores each having a circumscribed circle diameter of about 500 nm or more relative to a total area of the electrode discontinuous portions is about 15 percentage points or more lower at an end portion of each of the counter electrode portions than at a middle portion of each of the counter electrode portions.

Another example embodiment of the present invention provides a multilayer ceramic capacitor which includes a multilayer body including an inner layer portion including a plurality of inner dielectric layers and a plurality of internal electrode layers that are alternately laminated in a lamination direction, and outer layer portions sandwiching the inner layer portion from the lamination direction, the multilayer body further including two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction, and a pair of external electrodes each on a corresponding one of the two end surfaces and each connected to the plurality of internal electrode layers. The plurality of internal electrode layers each include electrode discontinuous portions where the plurality of internal electrode layers are discontinuous in counter electrode portions thereof where adjacent ones of the plurality of internal electrode layers in the lamination direction are opposed to each other. When viewing a cross section parallel or substantially parallel to the lamination direction and the length direction, a ratio of a total area of regions where Y segregates relative to a total area of the electrode discontinuous portions is about 20 percentage points or more lower at an end portion of each of the counter electrode portions than at a middle portion of each of the counter electrode portions.

According to example embodiments of the present invention, multilayer ceramic capacitors that each reduce or prevent electric field fringing in electrode discontinuous portions in the counter electrode portions of internal electrode layers and each have improved high-temperature reliability are provided.

The above and other elements, features, steps, characteristics advantages of the present invention will become more apparent from the following detailed description of the example embodiments with reference to the attached drawings.

### BRIEF DESCRIPTION OF THE DRAWINGS

FIG. 1 is a perspective view showing a multilayer ceramic capacitor according to an example embodiment of the present invention.

FIG. 2 is a cross-sectional view taken along the line II-II (LT cross-section) of the multilayer ceramic capacitor shown in FIG. 1.

FIG. 3 is a cross-sectional view taken along the line III-III (WT cross-section) of the multilayer ceramic capacitor shown in FIG. 1.

FIG. 4 is a schematic diagram showing the configuration of an inner layer portion of the multilayer ceramic capacitor shown in FIG. 1.

FIG. 5 is an enlarged view (LT cross-section) of an electrode discontinuous portion at an end portion of a counter electrode portion according to an example embodiment of the present invention.

FIG. 6 is an enlarged view (LT cross-section) of an electrode discontinuous portion at a middle portion of the counter electrode portion according to an example embodiment of the present invention.

FIG. 7 is an enlarged view (LT cross-section) of an electrode discontinuous portion at an end portion of the counter electrode portion according to an example embodiment of the present invention.

FIG. 8 is an enlarged view (LT cross-section) of an electrode discontinuous portion at a middle portion of the counter electrode portion according to an example embodiment of the present invention.

### DETAILED DESCRIPTION OF THE EXAMPLE EMBODIMENTS

Hereinafter, multilayer ceramic capacitors according to example embodiments of the present invention will be described with reference to the drawings. However, the present invention is not limited thereto. The drawings may be schematically simplified to explain the content of the present invention, and the ratio of dimensions of the components or between components shown in the drawings may not necessarily match the ratio of dimensions described in the specification. Also, components described in the specification may be omitted in the drawings, or the number of components may be reduced in the drawings.

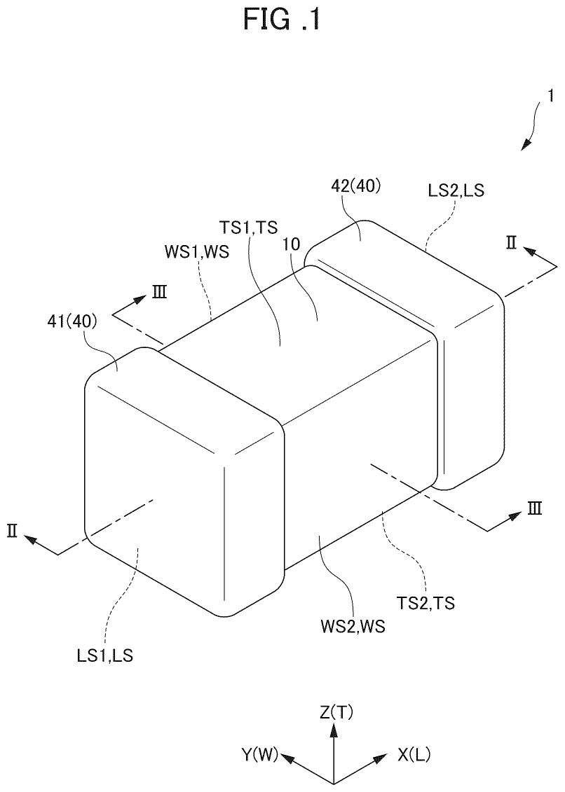

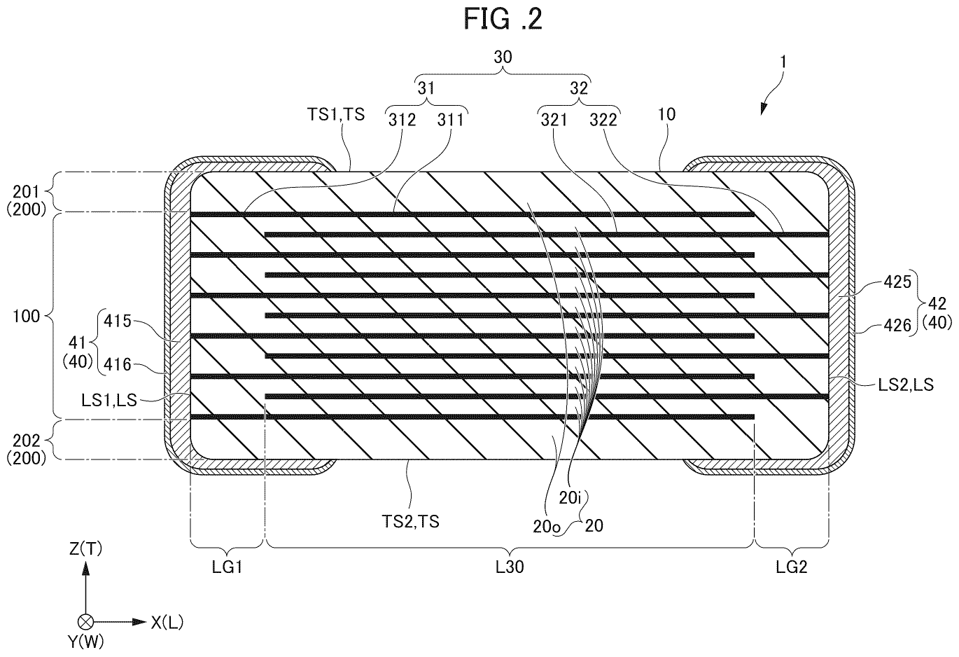

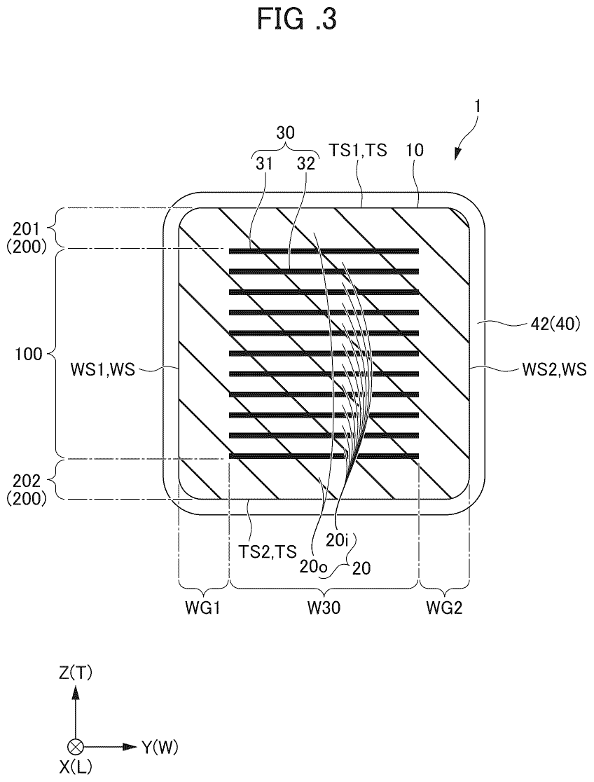

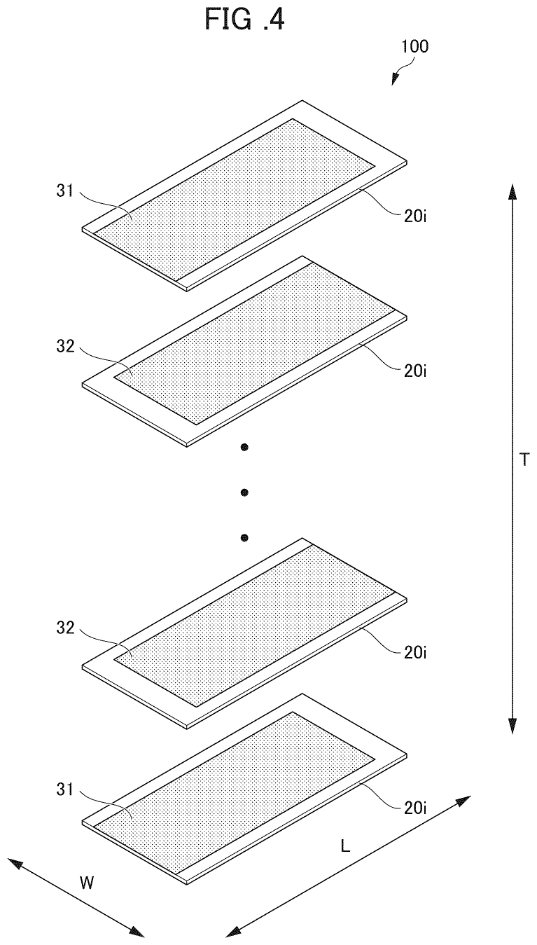

FIG. 1 is a perspective view showing a multilayer ceramic capacitor according to an example embodiment of the present invention. FIG. 2 is a cross-sectional view taken along the line II-II of the multilayer ceramic capacitor shown in FIG. 1. FIG. 3 is a cross-sectional view taken along the line III-III of the multilayer ceramic capacitor shown in FIG. 1. FIG. 4 is a schematic diagram showing the configuration of an inner layer portion of the multilayer ceramic capacitor shown in FIG. 1. The multilayer ceramic capacitor 1 shown in FIGS. 1 to 4 includes a multilayer body 10 and external electrodes 40. The external electrodes 40 include a first external electrode 41 and a second external electrode 42.

In FIGS. 1 to 3, an XYZ Cartesian coordinate system is shown. The X direction refers to the length direction L of the multilayer ceramic capacitor 1 and the multilayer body 10, the Y direction refers to the width direction W of the multilayer ceramic capacitor 1 and the multilayer body 10, and the Z direction refers to the lamination direction T of the multilayer ceramic capacitor 1 and the multilayer body 10. In view of the above, the cross section shown in FIG. 2 is also referred to as an LT cross section, and the cross section shown in FIG. 3 is also referred to as a WT cross section. In addition, the length direction L, the width direction W, and the lamination direction T are not necessarily orthogonal or substantially orthogonal to each other, and may intersect with each other.

The size of the multilayer ceramic capacitor preferably has, for example, a dimension in the length direction L of about 0.2 mm or more and about 10 mm or less, a dimension in the width direction W of about 0.1 mm or more and about 10 mm or less, and a dimension in the lamination direction T of about 0.1 mm or more and about 10 mm or less.

The multilayer body 10 has a rectangular or substantially rectangular parallelepiped shape and includes a first main surface TS1 and a second main surface TS2 opposed to each other in the lamination direction T, a first lateral surface WS1 and a second lateral surface WS2 opposed to each other in the width direction W, and a first end surface LS1 and a second end surface LS2 opposed to each other in the length direction L. The surfaces may include unevenness or may be roughened. When there is no particular need to distinguish between the first main surface TS1 and the second main surface TS2, they are collectively referred to as main surface TS, when there is no particular need to distinguish between the first end surface LS1 and the second end surface LS2, they are collectively referred to as end surface LS, and when there is no particular need to distinguish between the first lateral surface WS1 and the second lateral surface WS2, they are collectively referred to as lateral surface WS.

The corner portions and the ridge portions of the multilayer body 10 are preferably rounded. Each of the corner portions refers to a portion where three surfaces of the multilayer body 10 intersect with each other, and each of the ridge portions refers to a portion where two surfaces of the multilayer body 10 intersect with each other.

As shown in FIGS. 2 and 3, the multilayer body 10 includes a plurality of inner dielectric layers 20i and a plurality of internal electrode layers 30 laminated in the lamination direction T. Furthermore, the multilayer body 10 includes an inner layer portion 100, and a first outer layer portion 201 and a second outer layer portion 202 that sandwich the inner layer portion 100 in the lamination direction T.

The inner dielectric layers 20i in the inner layer portion 100 and the outer dielectric layers 20o in the outer layer portion 200 may have different compositions because the functions required by the inner layer portion 100 and the outer layer portion 200 are different. For example, the inner dielectric layers 20i need to have high permittivity, and the outer dielectric layers 20o need to have high moisture resistance, weather resistance, and strength. For this reason, the dielectric layers in the inner layer portion 100 are described as inner dielectric layers 20i, and the dielectric layers in the outer layer portion 200 are described as outer dielectric layers 20o. However, when there is no particular need to distinguish between the inner dielectric layers 20i and the outer dielectric layers 20o, they are collectively described as dielectric layers 20.

FIG. 4 schematically shows the configuration of the inner layer portion 100. The inner layer portion 100 includes a plurality of inner dielectric layers 20i and a plurality of internal electrode layers 30. In the inner layer portion 100, the plurality of internal electrode layers 30 are opposed to each other with a corresponding one of the inner dielectric layers 20i interposed therebetween. The inner layer portion 100 is a portion that generates capacitance and substantially defines and functions as a capacitor.

The plurality of dielectric layers 20 are made of a dielectric material. The dielectric material includes, for example, at least one of Ca, Zr, or Sr, and includes a material with a perovskite structure. More specifically, the dielectric material is a temperature-compensating dielectric material having a small temperature-dependent capacitance change rate, and includes, for example, at least one of Ca, Zr, or Sr as a main component of the dielectric material. For example, in the dielectric material, at least one of Ca or Sr defines the A site of the perovskite structure (ABO₃), and at least one of Zr, Ti, or Hf defines the B site of the perovskite structure.

The thickness of each of the inner dielectric layers 20i is not particularly limited, but is preferably about 0.2 μm or more and about 15 μm or less, for example. By reducing the thickness of each of the inner dielectric layers 20i, it is possible to improve the capacitance.

The first outer layer portion 201 is provided adjacent to the first main surface TS1 of the multilayer body 10, and the second outer layer portion 202 is provided adjacent to the second main surface TS2 of the multilayer body 10. More specifically, the first outer layer portion 201 is provided between the first main surface TS1 and the internal electrode layer 30 closest to the first main surface TS1 among the plurality of internal electrode layers 30, and the second outer layer portion 202 is provided between the second main surface TS2 and the internal electrode layer 30 closest to the second main surface TS2 among the plurality of internal electrode layers 30. Neither the first outer layer portion 201 nor the second outer layer portion 202 includes the internal electrode layer 30.

The outer layer portion 200 is made of an insulating material. The first outer layer portion 201 and the second outer layer portion 202 can each include a plurality of outer dielectric layers 20o, but may include a single outer dielectric layer 20o. The outer dielectric layer 20o can be made of the same type of dielectric material as the inner dielectric layer 20i, but may include components different from those of the inner dielectric layer 20i depending on the required function.

The plurality of internal electrode layers 30 include a plurality of first internal electrode layers 31 and a plurality of second internal electrode layers 32. The plurality of first internal electrode layers 31 and the plurality of second internal electrode layers 32 are alternately provided in the lamination direction T of the multilayer body 10.

Each of the first internal electrode layers 31 includes a counter electrode portion 311 and an extension electrode portion 312, and each of the second internal electrode layers 32 includes a counter electrode portion 321 and an extension electrode portion 322.

The counter electrode portion 311 and the counter electrode portion 321 are opposed to each other with a corresponding one of the inner dielectric layers 20i interposed therebetween in the lamination direction T of the multilayer body 10. The shapes of the counter electrode portion 311 and the counter electrode portion 321 are not particularly limited and may be, for example, rectangular or substantially rectangular. The counter electrode portion 311 and the counter electrode portion 321 are portions that generate capacitance and substantially define and function as a capacitor.

The extension electrode portions 312 each extend from the counter electrode portion 311 toward the first end surface LS1 of the multilayer body 10 and are each exposed at the first end surface LS1. The extension electrode portions 322 each extend from the counter electrode portion 321 toward the second end surface LS2 of the multilayer body 10 and are each exposed at the second end surface LS2. The lengths in the width direction W of the counter electrode portion 311 and the extension electrode portion 312 may be the same or different. These lengths in the width direction W may gradually change approaching the first end surface LS1 where they are exposed. The lengths in the width direction W of the counter electrode portion 321 and the extension electrode portion 322 may be the same or different. These lengths in the width direction W may gradually change approaching the second end surface LS2 where they are exposed.

Thus, the first internal electrode layers 31 are connected to the first external electrode 41, and there is a gap between the first internal electrode layers 31 and the second end surface LS2 of the multilayer body 10, that is, the second external electrode 42. Also, the second internal electrode layers 32 are connected to the second external electrode 42, and there is a gap between the second internal electrode layers 32 and the first end surface LS1 of the multilayer body 10, that is, the first external electrode 41.

The first internal electrode layers 31 and the second internal electrode layers 32 include, for example, metal Ni as a main component. Also, the first internal electrode layers 31 and the second internal electrode layers 32 may include, for example, at least one of Cu, Ag, Pd, Sn, or Au, or an alloy including at least one of these metals such as an Ag—Pd alloy, as the main component, or may include at least one of these as a component other than the main component. Furthermore, the first internal electrode layers 31 and the second internal electrode layers 32 may include, for example, dielectric particles having the same composition system as that of the ceramic included in the inner dielectric layer 20i as a component other than the main component. In addition, in the present specification, a metal which is the main component indicates the metal component having the highest weight percent.

The thickness of each of the first internal electrode layer 31 and the second internal electrode layer 32 is not particularly limited, but is, for example, preferably about 0.2 μm or more and about 2.0 μm or less, and more preferably about 0.30 μm or more and about 0.35 μm or less. The number of the first internal electrode layers 31 and the second internal electrode layers 32 is not particularly limited.

Examples of methods for measuring the thickness of the inner dielectric layer 20i and the internal electrode layer 30 include, for example, a method of observing an LT cross section near the middle in the width direction of the multilayer body exposed by polishing using a scanning electron microscope. Also, each value may be an average value of measurements at multiple locations in the length direction, or may be an average value of measurements at multiple locations in the lamination direction.

As shown in FIG. 3, the multilayer body 10 includes, in the width direction W, an electrode counter portion W30 where the internal electrode layers 30 are opposed to each other, and a first side gap portion WG1 and a second side gap portion WG2 that sandwich the electrode counter portion W30. The first side gap portion WG1 is located between the electrode counter portion W30 and the first lateral surface WS1, and the second side gap portion WG2 is located between the electrode counter portion W30 and the second lateral surface WS2. More specifically, the first side gap portion WG1 is located between the end of each of the internal electrode layers 30 adjacent to the first lateral surface WS1 and the first lateral surface WS1, and the second side gap portion WG2 is located between the end of each of the internal electrode layers 30 adjacent to the second lateral surface WS2 and the second lateral surface WS2. The first side gap portion WG1 and the second side gap portion WG2 do not include any internal electrode layer 30 and include only the dielectric layers 20. The first side gap portion WG1 and the second side gap portion WG2 are also referred to as W gaps.

As shown in FIG. 2, the multilayer body 10 includes, in the length direction L, an electrode counter portion L30 where the first internal electrode layers 31 and the second internal electrode layers 32 of the internal electrode layer 30 are opposed to each other, a first end gap portion LG1, and a second end gap portion LG2. The first end gap portion LG1 is located between the electrode counter portion L30 and the first end surface LS1, and the second end gap portion LG2 is located between the electrode counter portion L30 and the second end surface LS2. More specifically, the first end gap portion LG1 is located between the end of each of the second internal electrode layers 32 adjacent to the first end surface LS1 and the first end surface LS1, and the second end gap portion LG2 is located between the end of each of the first internal electrode layers 31 adjacent to the second end surface LS2 and the second end surface LS2. The first end gap portion LG1 does not include any second internal electrode layer 32 and includes the first internal electrode layers 31 and the inner dielectric layer 20i, and the second end gap portion LG2 does not include any first internal electrode layer 31 and includes the second internal electrode layers 32 and the inner dielectric layer 20i. The first end gap portion LG1 is a portion that functions as an extension electrode portion of each of the first internal electrode layers 31 toward the first end surface LS1, and the second end gap portion LG2 is a portion that functions as an extension electrode portion of each of the second internal electrode layers 32 toward the second end surface LS2. The first end gap portion LG1 and the second end gap portion LG2 are also referred to as L gaps.

The counter electrode portions 311 of the first internal electrode layers 31 and the counter electrode portions 321 of the second internal electrode layers 32 described above are located in the electrode counter portion L30. Also, the extension electrode portions 312 of the first internal electrode layers 31 described above are located in the first end gap portion LG1, and the extension electrode portions 322 of the second internal electrode layers 32 described above are located in the second end gap portion LG2.

Methods for measuring the thickness of the multilayer body 10 include, for example, a method of observing, using a scanning electron microscope, an LT cross section near the middle in the width direction of the multilayer body exposed by polishing, or a WT cross section near the middle in the length direction of the multilayer body exposed by polishing. Also, each value may be an average value of measurements at multiple locations in the length direction or width direction. Similarly, methods for measuring the length of the multilayer body 10 include, for example, a method of observing, using a scanning electron microscope, an LT cross section near the middle in the width direction of the multilayer body exposed by polishing. Also, each value may be an average value of measurements at multiple locations in the lamination direction. Similarly, methods for measuring the width of the multilayer body 10 include, for example, a method of observing, using a scanning electron microscope, a WT cross section near the middle in the length direction of the multilayer body exposed by polishing. Also, each value may be an average value of measurements at multiple locations in the lamination direction.

The external electrodes 40 include a first external electrode 41 and a second external electrode 42.

The first external electrode 41 is provided on the first end surface LS1 of the multilayer body 10 and is connected to the first internal electrode layers 31. The first external electrode 41 may extend from the first end surface LS1 toward a portion of the first main surface TS1 and a portion of the second main surface TS2. Also, the first external electrode 41 may extend from the first end surface LS1 toward a portion of the first lateral surface WS1 and a portion of the second lateral surface WS2.

The second external electrode 42 is provided on the second end surface LS2 of the multilayer body 10 and is connected to the second internal electrode layers 32. The second external electrode 42 may extend from the second end surface LS2 toward a portion of the first main surface TS1 and a portion of the second main surface TS2. Also, the second external electrode 42 may extend from the second end surface LS2 toward a portion of the first lateral surface WS1 and a portion of the second lateral surface WS2.

The first external electrode 41 includes a base electrode layer 415 and a plated layer 416, and the second external electrode 42 includes a base electrode layer 425 and a plated layer 426. The first external electrode 41 may include only the plated layer 416, or the second external electrode 42 may include only the plated layer 426.

The base electrode layer 415 and the base electrode layer 425 may be fired layers including metal and glass. Examples of the glass include glass components including at least one of B, Si, Ba, Mg, Al, Li, or the like. As a specific example, borosilicate glass can be used. The metal includes, for example, Cu as a main component. Further, the metal may include at least one of, for example, Ni, Ag, Pd, or Au, or alloys such as an Ag—Pd alloy as a main component, or may include them as components other than the main component.

The fired layer is a layer obtained by applying an electrically conductive paste including metal and glass to the multilayer body by, for example, a dipping method, and firing the paste. The firing may be performed after firing the internal electrode layers, or may be performed simultaneously with the internal electrode layers. Further, the fired layer may include a plurality of layers.

Alternatively, the base electrode layer 415 and the base electrode layer 425 may be, for example, resin layers including electrically conductive particles and a thermosetting resin. The resin layer may be provided on the above-described fired layer, or may be directly provided on the multilayer body without providing the fired layer.

The resin layer is obtained by, for example, applying an electrically conductive paste including electrically conductive particles and a thermosetting resin to a multilayer body by a coating method, and firing the paste. The firing may be performed after firing the internal electrode layers, or may be fired simultaneously with firing of the internal electrode layers. The resin layer may include a plurality of layers.

The thickness per layer of each of the base electrode layer 415 and the base electrode layer 425 functioning as the fired layer or the resin layer is not particularly limited, and may be, for example, about 2 μm or more and about 220 μm or less.

Alternatively, the base electrode layer 415 and the base electrode layer 425 may be, for example, thin film layers of about 1 μm or less in which metal particles are deposited, formed by a thin film formation method such as sputtering or vapor deposition, for example.

The plated layer 416 covers at least a portion of the base electrode layer 415, and the plated layer 426 covers at least a portion of the base electrode layer 425. The plated layer 416 and the plated layer 426 include, for example, at least one of Cu, Ni, Ag, Pd, or Au, or alloys such as an Ag—Pd alloy.

The plated layer 416 and the plated layer 426 may each include a plurality of layers. Preferably, for example, it has a two-layer structure of a Ni plating and an Sn plating. The Ni plated layer can prevent the base electrode layer from being eroded by solder when mounting the ceramic electronic component, and the Sn plated layer improves the wettability of solder when mounting the ceramic electronic component, thus enabling easy mounting. The plated layer 416 and the plated layer 426 can also have a three-layer structure by, for example, laminating Cu plating, Ni plating, and Sn plating, respectively. The outermost layer may be Au plating.

The thickness per layer of each of the plated layer 416 and the plated layer 426 is not particularly limited, and may be, for example, about 1 μm or more and about 10 μm or less.

Hereinafter, a first example embodiment of a multilayer ceramic capacitor according to the present invention will be described. In the first example embodiment, for example, the distribution state of pores AH each having a circumscribed circle diameter of about 500 nm or more in the electrode discontinuous portions FR of the internal electrode layers 30 is adjusted. The circumscribed circle diameter refers to the diameter of a virtual circle circumscribing the pore AH in a cross section parallel or substantially parallel to the lamination direction T and the length direction L.

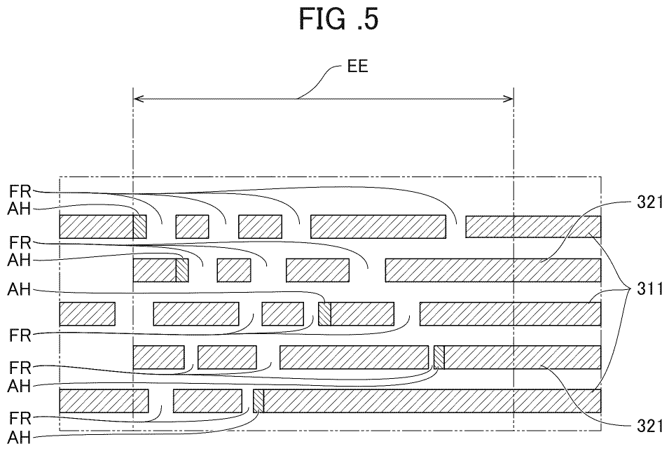

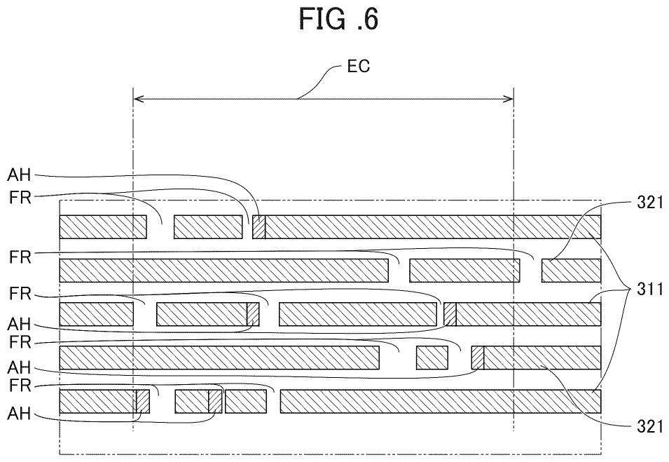

The internal electrode layers 30 each include electrode discontinuous portions FR where the internal electrode layer 30 is discontinuous in the counter electrode portions 311 or 321 where adjacent internal electrode layers 30 in the lamination direction T are opposed to each other, and when viewing a cross section parallel to the lamination direction T and the length direction L, that is, an LT cross section, the ratio of the total area of pores AH each having a circumscribed circle diameter of about 500 nm or more to the total area of the electrode discontinuous portions FR is, for example, lower by about 15 percentage points or more at the end portion EE of the counter electrode portions 311 or 321 than at the middle portion EC of the counter electrode portions 311 or 321 (FIGS. 5 and 6).

The end portion EE of the counter electrode portions 311 or 321 refers to a portion within a range of about 50 μm in length in the length direction L from the terminal end of the counter electrode portions 311 or 321 toward the middle in the length direction L (FIG. 5). Further, the middle portion EC of the counter electrode portions 311 or 321 refers to a portion within a range of about 50 μm in length in the length direction L centered on the middle of the counter electrode portions 311 or 321 in the length direction L (FIG. 6).

When pores AH each having a circumscribed circle diameter of about 500 nm or more exist in the electrode discontinuous portions FR at the end portion EE of the counter electrode portions 311 or 321 of the internal electrode layers 30, the substantial thickness of the dielectric layer 20 that shares the fringing electric field becomes thinner. Therefore, the electric field strength applied to the dielectric layer existing in the electrode discontinuous portions FR increases, and high-temperature reliability decreases. The multilayer ceramic capacitor 1 of the present example embodiment improves high-temperature reliability by reducing the ratio of the area where pores AH each having a circumscribed circle diameter of, for example, about 500 nm or more exist in the electrode discontinuous portions FR at the end portion EE of the counter electrode portions 311 or 321 of the internal electrode layers 30.

Next, a second example embodiment of a multilayer ceramic capacitor according to the present invention will be described. In the second example embodiment, the segregation state of predetermined elements in the electrode discontinuous portions FR of each of the internal electrode layers 30 is adjusted.

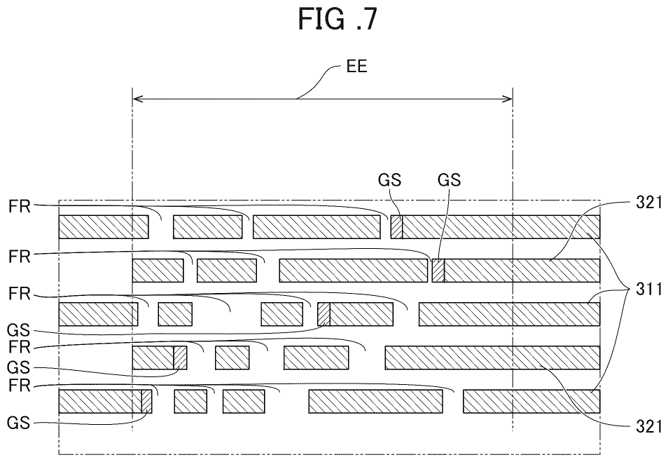

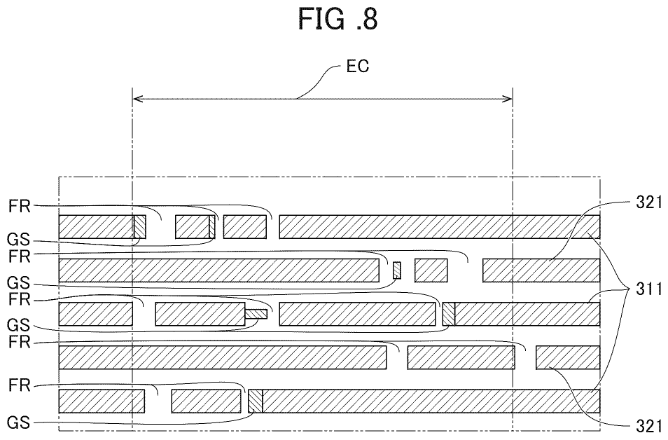

The internal electrode layers 30 each include electrode discontinuous portions FR where the internal electrode layer 30 is discontinuous in the counter electrode portions 311 or 321 where adjacent internal electrode layers 30 in the lamination direction T are opposed to each other, and when viewing a cross section parallel to the lamination direction T and the length direction L, that is, an LT cross section, the ratio of the total area of regions GS where Y (yttrium) segregates to the total area of the electrode discontinuous portions FR is, for example, lower by about 20 percentage points or more at the end portion EE of the counter electrode portions 311 or 321 than at the middle portion EC of the counter electrode portions 311 or 321 (FIGS. 7 and 8).

The end portion EE of the counter electrode portions 311 or 321 refers to a portion within a range of about 50 μm in length in the length direction L from the terminal end of the counter electrode portions 311 or 321 toward the middle in the length direction L (FIG. 7). Further, the middle portion EC of the counter electrode portions 311 or 321 refer to a portion within a range of about 50 μm in length in the length direction L centered on the middle of the counter electrode portions 311 or 321 in the length direction L (FIG. 8).

Y has a lower resistivity than the dielectric of the dielectric layers 20. Therefore, when segregation including Y exists in the electrode discontinuous portions FR at the end portion EE of the counter electrode portions 311 or 321 of the internal electrode layers 30, the electric field shared by the segregation of the fringing electric field becomes lower, and the electric field strength shared by the region in the lamination direction T of the dielectric layer other than the segregation increases, resulting in decreased high-temperature reliability. The multilayer ceramic capacitor 1 of the present example embodiment improves high-temperature reliability by reducing or preventing the segregation of Y in the electrode discontinuous portions FR at the end portion EE of the counter electrode portions 311 or 321 of the internal electrode layers 30.

Next, an example of a method for manufacturing a multilayer ceramic capacitor will be described.

First, ceramic green sheets for manufacturing dielectric layers and electrically conductive paste for manufacturing internal electrodes are prepared. The electrically conductive paste for manufacturing internal electrodes includes a binder and a solvent, and known organic binders and organic solvents can be used. The electrically conductive paste for manufacturing internal electrodes forms the internal electrodes 53.

Next, an electrically conductive paste for manufacturing internal electrodes is printed in a predetermined pattern on the ceramic green sheet by, for example, screen printing or gravure printing, thereby forming an internal electrode pattern.

Next, a predetermined number of ceramic green sheets for manufacturing outer layers on which no internal electrode pattern is formed are laminated, ceramic green sheets on which internal electrodes are formed are sequentially laminated thereon, and a predetermined number of ceramic green sheets for manufacturing outer layers are laminated thereon, thereby producing a multilayer sheet. The ceramic green sheets form the dielectric layers 20 of the multilayer ceramic capacitor 1.

A multilayer block is produced by pressing the obtained multilayer sheet in the lamination direction by, for example, hydrostatic pressing. Next, the multilayer block is cut to a predetermined size, and multilayer chips are cut out. At this time, corner portions and ridge portions of the multilayer chips may be rounded by, for example, barrel polishing or the like.

Furthermore, the multilayer body 10 is produced by firing the multilayer chips. The firing temperature at this time is, for example, preferably about 900° C. or more and about 1300° C. or less, although it depends on the materials of the dielectric and internal electrodes.

The distribution of pores AH each having a circumscribed circle diameter of about 500 nm or more or regions GS where Y segregates, which are formed in the electrode discontinuous portions FR at the end portion EE and the middle portion EC of the counter electrode portions 311 or 321 of the internal electrode layers, can both be controlled by adjusting the oxygen partial pressure in the step of firing the multilayer chips.

Next, by immersing the first end surface LS1 of the multilayer body 10 in an electrically conductive paste which is an electrode material for manufacturing the base electrode layer using, for example, a dipping method, the electrically conductive paste for manufacturing the base electrode layer 415 is applied to the first end surface LS1. Similarly, by immersing the second end surface LS2 of the multilayer body 10 in an electrically conductive paste which is an electrode material for manufacturing the base electrode layer using, for example, a dipping method, the electrically conductive paste for manufacturing the base electrode layer 425 is applied to the second end surface LS2. Thereafter, these electrically conductive pastes are fired to form the base electrode layer 415 and the base electrode layer 425, which are fired layers. The firing temperature is, for example, preferably about 600° C. or more and about 900° C. or less.

As described above, for example, the base electrode layer 415 and the base electrode layer 425, which are resin layers, may be formed by applying and firing an electrically conductive paste including electrically conductive particles and a thermosetting resin by a coating method, or the base electrode layer 415 and the base electrode layer 425, which are thin films, may be formed by a thin film formation method such as sputtering or vapor deposition, for example.

Thereafter, the first external electrode 41 is formed by forming the plated layer 416 on the surface of the base electrode layer 415, and the second external electrode 42 is formed by forming the plated layer 426 on the surface of the base electrode layer 425. Through the above steps, the multilayer ceramic capacitor 1 is obtained.

### EXAMPLES

An evaluation test performed on the multilayer ceramic capacitor 1 according to the first example embodiment will be described. Multilayer ceramic capacitors having the following specifications were used as samples, and samples with adjusted pore distribution states were manufactured on a lot-by-lot basis. The samples in each lot were manufactured under the same manufacturing conditions. For each Example and Comparative Example, n=5 samples for measuring the distribution of pores AH each having a circumscribed circle diameter of 500 nm or more and n=77 samples for high-temperature load testing were taken out from the same lot and prepared. In the measurement of the distribution of pores AH each having a circumscribed circle diameter of about 500 nm or more, the average value of the measurement results was used for evaluation.
Dimensions of multilayer ceramic capacitor: (L dimension) about 3.15 mm, (W dimension) about 1.65 mm, (T dimension) about 1.65 mm
Ceramic material: (Ba, Sr, Ca) ZrO₃
Capacitance: about 0.01 μF
Internal electrode layer: Ni

After impregnating and curing epoxy resin in the peripheral portion of the sample, the sample together with the epoxy resin was polished to about ½ in the width direction, and the LT cross-section at the end portion EE of the counter electrode portions 311 or 321 of the internal electrode layer 30 and the LT cross-section at the middle portion EC of the counter electrode portions 311 or 321 of the internal electrode layers 30 were observed using a field emission scanning electron microscope (FE-SEM), and a composition image by backscattered electrons (backscattered electron composition image) was acquired. The observation conditions were a measurement target range of about 50 μm×about 50 μm, an acceleration voltage of about 15 kV, and an image size of about 240×about 240 pix.

The obtained backscattered electron composition image was subjected to binarization processing using image analysis software, and the number of pixels in the region occupied by the electrode discontinuous portion FR and the number of pixels in the region occupied by pores AH each having a circumscribed circle diameter of about 500 nm or more were determined at the end portion EE and the middle portion EC of the counter electrode portions 311 or 321 of the internal electrode layers 30, and the ratio of the total area of pores AH each having a circumscribed circle diameter of about 500 nm or more to the total area of the electrode discontinuous portions FR is calculated from the ratio of these pixel numbers.

The method for measuring the circumscribed circle diameter of pores was, for example, to perform binarization processing on the composition image by backscattered electrons (backscattered electron composition image) using image analysis software, determine the circumscribed circle for the pore portion (dark portion), calculate the diameter of such circumscribed circle, and define this as the circumscribed circle diameter.
Applied voltage: about 756 V (×1.2 W.V.)
Temperature: about 125° C.
Judgment criteria: When the time until failure occurs for the sample that failed earliest is less than about 2000 hours, it is rated as × (cross symbol indicating fail), and when it is about 2000 hours or more, it is rated as ◯ (circle symbol indicating pass).

TABLE 1

| | Area ratio of pores (%) | | | High- | |
|---|---|---|---|---|---|
| | | | Middle | temperature | |
| | End | Middle | portion − | load test | |
| | portion | portion | End portion | time(h r) | Judgment |
| Example 1 | 77 | 92 | 15 | 3409 | ◯ |
| Example 2 | 63 | 88 | 25 | 3210 | ◯ |
| Example 3 | 21 | 54 | 33 | 3412 | ◯ |
| Example 4 | 38 | 78 | 40 | 3694 | ◯ |
| Comparative | 78 | 82 | 4 | 1912 | × |
| Example 1 | | | | | |

Regarding the ratio of the total area of pores AH each having a circumscribed circle diameter of about 500 nm or more to the total area of the electrode discontinuous portions FR, it was confirmed as a good result when the end portion EE of the counter electrode portion was lower than the middle portion EC of the counter electrode portion by about 15 percentage points or more.

An evaluation test performed on the multilayer ceramic capacitor 1 according to the second example embodiment will be described. Using the multilayer ceramic capacitors with the above specifications as samples, samples with adjusted Y segregation states were manufactured on a lot-by-lot basis. Samples within each lot were manufactured under the same manufacturing conditions. For each Example and Comparative Example, n=5 samples for segregation state measurement and n=77 samples for high-temperature load test were taken out from the same lot and prepared. In the measurement of the segregation state, evaluation was performed using the average value of the measurement results.

The region where Y segregates can be defined by cps (Count per second), which is the number of X-ray photons per unit time by WDX. Specifically, from the element mapping of FE-WDX, cells where the Y count number is equal to or greater than a predetermined value (unit: cps) are defined as the region GS where Y segregates. The reference count number for the region where Y segregates is about 30 cps or more.

The area of the region GS where Y segregates can be indicated by the number of cells exhibiting about 30 cps or more. In addition, the area of the electrode discontinuous portion FR can be indicated by the number of cells in the region corresponding to the electrode discontinuous portion FR. Thus, the ratio of the total area of the region GS where Y segregates to the total area of the electrode discontinuous portions FR can be calculated.

The specific measurement method is as follows:
Impregnate and cure epoxy resin in the peripheral portion of the measurement sample.
Polish the measurement sample including the epoxy resin to the middle in the width direction W in an orientation that allows observation of a cross-section parallel or substantially parallel to the length direction L and the lamination direction T.
Perform element mapping with FE-WDX (device name: EPMA-8050G (product name)).
The observation conditions were about 3300-times magnification, an acceleration voltage of about 15 kV, an image size of about 240×about 240 pix, an integration time of about 45 ms/pix, and a beam current of about 50 nA, and the Y count number (cps) was quantified for each cell.
Applied voltage: about 756 V (×1.2 W.V.)
Temperature: about 125° C.
Judgment criteria: When the time until failure occurs for the sample that failed earliest is less than about 2000 hours, it is rated as × (cross symbol indicating fail), and when it is about 2000 hours or more, it is rated as ◯ (circle symbol indicating pass).

TABLE 2

| | Area ratio of Y segregation (%) | | | High- | |
|---|---|---|---|---|---|
| | | | Middle | temperature | |
| | End | Middle | portion − | load test | |
| | portion | portion | End portion | time(hr) | Judgment |
| Example 1 | 11 | 67 | 56 | 2045 | ◯ |
| Example 2 | 20 | 65 | 45 | 2290 | ◯ |
| Example 3 | 29 | 61 | 32 | 2120 | ◯ |
| Example 4 | 43 | 63 | 20 | 2689 | ◯ |
| Example 5 | 14 | 44 | 30 | 3098 | ◯ |
| Example 6 | 8 | 34 | 26 | 3211 | ◯ |
| Example 7 | 3 | 32 | 29 | 3334 | ◯ |
| Example 8 | 11 | 32 | 21 | 3412 | ◯ |
| Example 9 | 3 | 27 | 24 | 3191 | ◯ |
| Example 10 | 14 | 42 | 28 | 3202 | ◯ |
| Example 11 | 15 | 38 | 23 | 3186 | ◯ |
| Example 12 | 13 | 39 | 26 | 3008 | ◯ |
| Example 13 | 15 | 37 | 22 | 3190 | ◯ |
| Example 14 | 11 | 32 | 21 | 3208 | ◯ |
| Example 15 | 12 | 36 | 24 | 3118 | ◯ |
| Example 16 | 7 | 35 | 28 | 3161 | ◯ |
| Comparative | 52 | 70 | 18 | 1890 | × |
| Example 1 | | | | | |

It was confirmed as a good result in the evaluation of high-temperature reliability when the ratio of the total area of Y segregation to the total area of the electrode discontinuous portions FR was about 20 percentage points or more lower at the end portion EE of the counter electrode portions 311 or 321 than at the middle portion EC of the counter electrode portions 311 or 321.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of inner dielectric layers and a plurality of internal electrode alternately laminated in a lamination direction, and outer layer portions sandwiching the inner layer portion from the lamination direction, the multilayer body further including two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction; and
a pair of external electrodes each on a corresponding one of the two end surfaces and each connected to the plurality of internal electrode layers; wherein
the plurality of internal electrode layers each include electrode discontinuous portions where the plurality of internal electrode layers are discontinuous in counter electrode portions thereof where adjacent ones of the plurality of internal electrode layers in the lamination direction are opposed to each other; and
when viewing a cross section parallel or substantially parallel to the lamination direction and the length direction:
a ratio of a total area of pores each having a circumscribed circle diameter of about 500 nm or more relative to a total area of the electrode discontinuous portions is about 15 percentage points or more lower at an end portion of each of the counter electrode portions than at a middle portion of each of the counter electrode portions.

2. The multilayer ceramic capacitor according to claim 1, wherein
a dimension of the multilayer ceramic capacitor in the length direction is about 0.2 mm or more and about 10 mm or less;
a dimension of the multilayer ceramic capacitor in the width direction is about 0.1 mm or more and about 10 mm or less; and
a dimension of the multilayer ceramic capacitor in the lamination direction is about 0.1 mm or more and about 10 mm or less.

3. The multilayer ceramic capacitor according to claim 1, wherein each of the plurality of inner dielectric layers includes at least one of Ca, Zr, or Sr, and includes a material with a perovskite structure.

4. The multilayer ceramic capacitor according to claim 1, wherein a thickness of each of the plurality of inner dielectric layers is about 0.2 μm or more and about 15 μm or less.

5. The multilayer ceramic capacitor according to claim 1, wherein each of the plurality of internal electrode layers includes Ni as a main component.

6. The multilayer ceramic capacitor according to claim 1, wherein each of the plurality of internal electrode layers includes at least one of Cu, Ag, Pd, Sn, or Au, or an alloy including at least one of Cu, Ag, Pd, Sn, or Au as the main component.

7. The multilayer ceramic capacitor according to claim 1, wherein a thickness of each of the plurality of internal electrode layers is about 0.2 μm or more and about 2.0 μm or less.

8. The multilayer ceramic capacitor according to claim 1, wherein a thickness of each of the plurality of internal electrode layers is about 0.30 μm or more and about 0.35 μm or less.

9. The multilayer ceramic capacitor according to claim 1, wherein each of the pair of external electrodes includes a base electrode layer and a plated layer on the base electrode layer.

10. The multilayer ceramic capacitor according to claim 9, wherein the base electrode layer includes metal and glass.

11. A multilayer ceramic capacitor comprising:
a multilayer body including an inner layer portion including a plurality of inner dielectric layers and a plurality of internal electrode layers alternately laminated in a lamination direction, and outer layer portions sandwiching the inner layer portion from the lamination direction, the multilayer body further including two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction; and
a pair of external electrodes each on a corresponding one of the two end surfaces and each connected to the plurality of internal electrode layers; wherein
the plurality of internal electrode layers each include electrode discontinuous portions where the plurality of internal electrode layers are discontinuous in counter electrode portions thereof where adjacent ones of the plurality of internal electrode layers in the lamination direction are opposed to each other; and
when viewing a cross section parallel or substantially parallel to the lamination direction and the length direction:
a ratio of a total area of regions where Y segregates relative to a total area of the electrode discontinuous portions is about 20 percentage points or more lower at an end portion of each of the counter electrode portions than at a middle portion of each of the counter electrode portions.

12. The multilayer ceramic capacitor according to claim 11, wherein
a dimension of the multilayer ceramic capacitor in the length direction is about 0.2 mm or more and about 10 mm or less;
a dimension of the multilayer ceramic capacitor in the width direction is about 0.1 mm or more and about 10 mm or less, and
a dimension of the multilayer ceramic capacitor in the lamination direction is about 0.1 mm or more and about 10 mm or less.

13. The multilayer ceramic capacitor according to claim 11, wherein each of the plurality of inner dielectric layers includes at least one of Ca, Zr, or Sr, and includes a material with a perovskite structure.

14. The multilayer ceramic capacitor according to claim 11, wherein a thickness of each of the plurality of inner dielectric layers is about 0.2 μm or more and about 15 μm or less.

15. The multilayer ceramic capacitor according to claim 11, wherein each of the plurality of internal electrode layers includes Ni as a main component.

16. The multilayer ceramic capacitor according to claim 11, wherein each of the plurality of internal electrode layers includes at least one of Cu, Ag, Pd, Sn, or Au, or an alloy including at least one of Cu, Ag, Pd, Sn, or Au as the main component.

17. The multilayer ceramic capacitor according to claim 11, wherein a thickness of each of the plurality of internal electrode layers is about 0.2 μm or more and about 2.0 μm or less.

18. The multilayer ceramic capacitor according to claim 11, wherein a thickness of each of the plurality of internal electrode layers is about 0.30 μm or more and about 0.35 μm or less.

19. The multilayer ceramic capacitor according to claim 11, wherein each of the pair of external electrodes includes a base electrode layer and a plated layer on the base electrode layer.

20. The multilayer ceramic capacitor according to claim 19, wherein the base electrode layer includes metal and glass.
